(19) United States
(12) Patent Application Publication
(10) Pub. No.: US 2009/0224034 A1
(43) Pub. Date: Sep. 10, 2009

(54) INFORMATION PROCESSING APPARATUS

(75) Inventors: Akiyasu Yamamoto, Yokohama-shi (JP); Katsumi Adachi, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/353,122

(22) Filed: Jan. 13, 2009

(30) Foreign Application Priority Data
Mar. 7, 2008 (JP) 2008-058460

(51) Int. Cl. G06K 5/00

(52) U.S. Cl. 235/380

(57) ABSTRACT

According to one embodiment, an information processing apparatus includes a communication device which is provided in a casing and executes wireless communication with a non-contact type IC card, and a storing module which stores the non-contact type IC card, the storing module being provided at such a position that communication is enabled between the non-contact type IC card that is stored and the communication device.

### CROSS-REFERENCE TO RELATED APPLICATIONS

This application is based upon and claims the benefit of priority from Japanese Patent Application No. 2008-058460, filed Mar. 7, 2008, the entire contents of which are incorporated herein by reference.

### BACKGROUND

1. Field

One embodiment of the invention relates to an information processing apparatus in which a communication device, which executes wireless communication with a non-contact type IC card, is mounted.

2. Description of the Related Art

In recent years, there are known information processing apparatuses, such as personal computers, in which communication devices, which execute wireless communication non-contact type IC cards, are mounted. Some types of non-contact type IC cards have functions of use as tickets for transport facilities such as trains, or as electronic money in on-line shopping via general shops or networks.

The non-contact type IC card executes data transmission/reception by generating power by electromagnetic induction, on the basis of radio waves which are emitted from a communication device. Hence, in the state in which the non-contact type IC is placed close to the communication device, no power is generated since no variation occurs in magnetic field, and the non-contact type IC cannot be used. Thus, the user is required to perform, each time the communication is executed, an operation of holding the non-contact type IC card over the communication device (i.e. an operation of approaching the non-contact type IC card from a position apart from the communication device to a predetermined distance to the communication device, and then moving the non-contact type IC card away from the communication device).

Conventionally, there has been devised a data communication method which enables copying of the content of one non-contact type IC card to another non-contact type IC card. For example, in a data communication method disclosed in Jpn. Pat. Appln. KOKAI Publication No. 2002-24778, two IC cards are laid over a reader/writer, and the antenna of the reader/writer is coupled with the antennas of the two IC cards, thereby realizing copying of data between the two IC cards.

As described above, in the conventional information processing apparatus, in the case of receiving and processing data from the non-contact type IC card, it is necessary for the user to perform the operation of holding the non-contact type IC card over the communication device that is provided on the information processing apparatus. Thus, in the case of using the non-contact type IC card twice or more, the same operation has to be repeated each time, and the handling of the IC card is not easy.

In a data communication method of Jpn. Pat. Appln. KOKAI Publication No. 2002-24778, data copy between two IC cards is realized by placing the two IC cards on the reader/writer. Prior to executing the copy, however, it is necessary to execute a process for each IC card. Specifically, a first IC card is placed on the reader/writer and a predetermined process is executed by reading data from the first IC card, following which the placement of a second IC card is instructed. If the second IC card is placed on the reader/writer, the second IC card is recognized, and the content stored in the memory is confirmed. In short, in the conventional data communication method, it is necessary to perform an operation of individually placing two IC cards on the reader/writer. Thus, when the work of copying data between two IC cards is executed twice or more, it is necessary to perform, at each time of copy, the operation of placing the two IC cards on the reader/writer, and the handling of the IC cards is not easy.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an example of the state in which a display unit of a computer according to an embodiment of the present invention is opened;

FIG. 2 shows an example of the cross section along line A-A in FIG. 1 in the embodiment;

FIG. 3 is a block diagram showing an example of the system configuration of the computer according to the embodiment;

FIG. 4 shows an example of the relationship between hardware and software for controlling an IC card reader/writer in the embodiment;

FIG. 5 is a block diagram showing an example of the structure of a non-contact type IC card in the embodiment;

FIG. 6 shows an example of the relative positional relationship between the IC card reader/writer, a non-contact type IC card and another non-contact type IC card, as viewed from the lateral side, in the embodiment;

FIG. 7 shows an example of the positional relationship between the IC card reader/writer and external and built-in non-contact type IC cards in the embodiment;

FIG. 8 shows an example of time periods of communication between two non-contact type IC cards and the IC card reader/writer in the embodiment;

FIG. 9 is a flow chart illustrating an example of a built-in IC card detection process in the embodiment;

FIG. 10 is a flow chart illustrating an example of a IC card process for executing card settlement by a non-contact type IC card having a charge settlement function (e.g. electronic money) in the embodiment;

FIG. 11 shows an example of a first IC card process for a transaction of data between two non-contact type IC cards via the IC card reader/writer in the embodiment;

FIG. 12 shows an example of a second IC card process for a transaction of data between two external non-contact type IC cards via the IC card reader/writer and a built-in non-contact type IC card in the embodiment;

FIG. 13 is a flow chart illustrating an example of the first IC card process in the embodiment; and

FIG. 14 is a flow chart illustrating an example of the second IC card process in the embodiment.

### DETAILED DESCRIPTION

Various embodiments according to the invention will be described hereinafter with reference to the accompanying drawings. In general, according to one embodiment of the invention, there is provided an information processing apparatus comprising: a communication device which is provided in a casing and executes wireless communication with a non-contact type IC card; and a storing module which stores the non-contact type IC card, the storing module being provided at such a position that communication is enabled between the non-contact type IC card that is stored and the communication device.

An embodiment of the present invention will now be described with reference to the accompanying drawings.

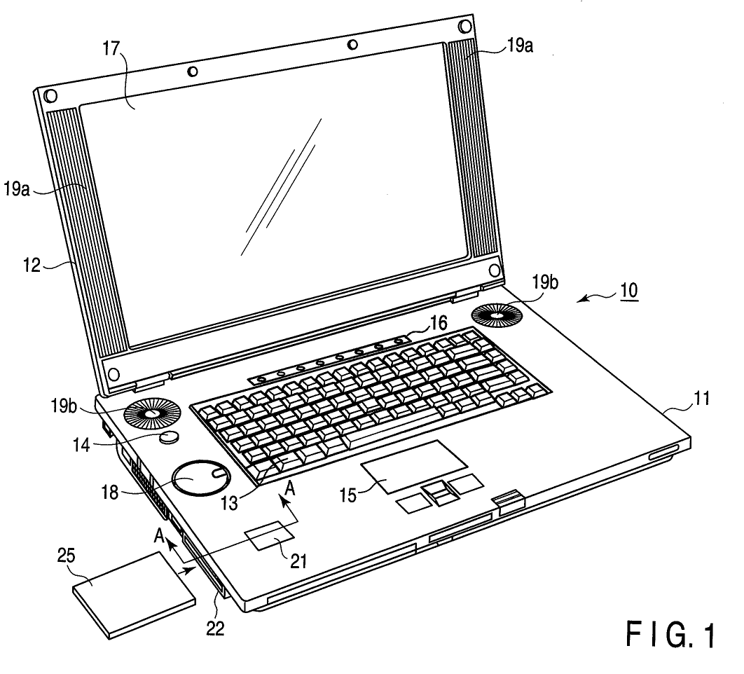

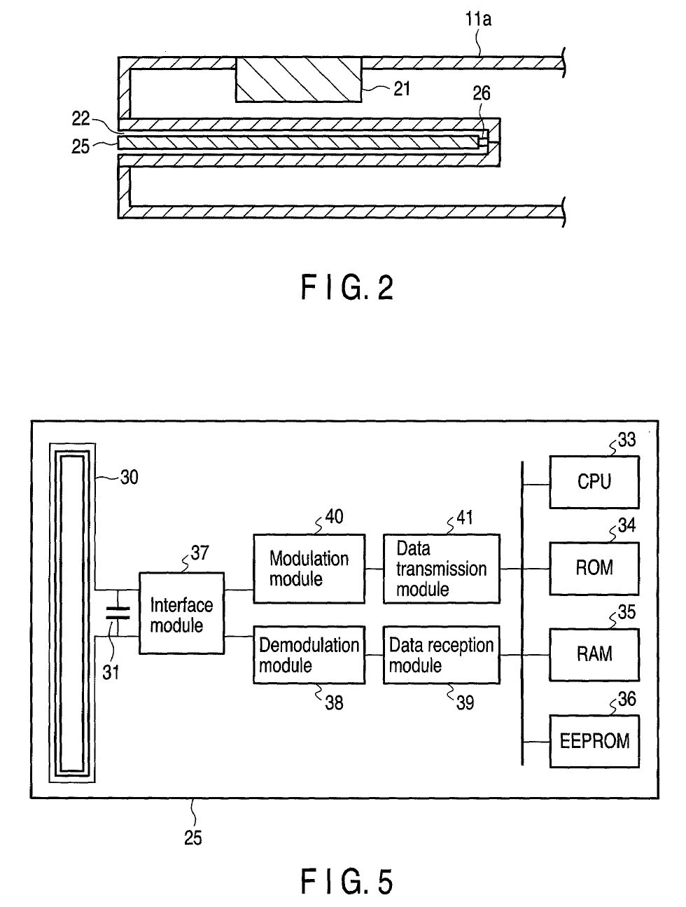

To begin with, referring to FIG. 1 and FIG. 2, the structure of an information processing apparatus according to an embodiment of the invention is described. The information processing apparatus is realized, for example, as a battery-powerable notebook portable personal computer 10 (hereinafter referred to simply as “computer 10”).

FIG. 1 is a perspective view that shows the state in which a display unit of the computer 10 is opened. The computer 10 comprises a computer main body 11 and a display unit 12. A display device that is composed of an LCD (Liquid Crystal Display) 17 is built in the display unit 12. The display screen of the LCD 17 is positioned at an approximately central part of the display unit 12. A pair of speakers (tweeters) 19a are disposed on both sides of the LCD 17.

The display unit 12 is attached to the computer main body 11 such that the display unit 12 is freely rotatable between an open position where the top surface of the computer main body 11 is exposed and a closed position where the top surface of the computer main body 11 is covered. The computer main body 11 has a thin box-shaped casing in which a battery can be detachably mounted.

A keyboard 13, a power button 14 for powering on/off the computer 10, a touch pad 15, an audio/video (AV) operation panel 16, an AV controller, a volume control dial 18 and a pair of speakers 19b are disposed on the top surface of the casing of the computer main body 11. The keyboard 13 has a plurality of keys including four direction keys (upward, downward, leftward and rightward keys) and other various keys (alphabet keys, numeral keys, auxiliary keys, etc.).

The computer 10 has an AV function for playing back various media such as TV broadcast programs, moving picture data, still images and music. The AV operation panel 16 includes a plurality of buttons for controlling the AV function of the computer 10. Each of these buttons is composed of an electrostatic switch. An LED light-transmission area is disposed at a central part of each electrostatic switch. Light from an LED, which is provided in association with each of the electrostatic switches, is emitted to the outside through the associated LED light-transmission area.

The buttons of the AV operation panel 16 include a TV button, a CD/DVD button and an LED on/off button. The TV button is a button for instructing the start of a TV function for viewing/listening to or recording TV broadcast programs. The CD/DVD button is a button for instructing the start of a CD/DVD function for playing back content stored in CD media or DVD media. The LED on/off button is a button for controlling each LED in the AV operation panel 16.

An IC card reader/writer 21 (communication device) is provided on a top surface portion of the computer main body 11 of the computer 10 according to the embodiment. The IC card reader/writer 21 executes data transmission/reception by wireless communication with a non-contact type IC card 25. The IC card reader/writer 21 includes a magnetic field radiation module which radiates an induction magnetic field, and generates a constant magnetic field in a case where data transmission/reception is executed with the non-contact type IC card 25. If the user performs an operation of holding the non-contact type IC card 25 over the IC card reader/writer 21 (i.e. approaching the non-contact type IC card 25 to the IC card reader/writer 21), electric power is induced by the magnetic field that is generated from the IC card reader/writer 21. The IC card reader/writer 21 executes an operation for data transmission/reception by the induced power.

The computer 10 according to the present embodiment is provided with a storing module. The storing module can receive the non-contact type IC card 25, which is inserted from a non-contact type IC card slot 22 that is provided on a side (a left side in FIG. 1) of the casing of the computer main body 11. The storing module is provided under the IC card reader/writer 21 which is provided on the upper surface of the casing of the computer main body 11. The storing module is disposed near the IC card reader/writer 21 so as to enable stable communication between the non-contact type IC card 25, which is stored in the storing module, and the IC card reader/writer 21.

FIG. 2 is a cross-sectional view taken along line A-A in FIG. 1. FIG. 2 shows the state in which the non-contact type IC card 25 is accommodated in the storing module.

As is shown in FIG. 2, the non-contact type IC card 25 is stored in the storing module from the non-contact type IC card slot 22. Thereby, the non-contact type IC card 25 is built in the computer main body 11 at a position close to the IC card reader/writer 21.

In the storing module, a card detection sensor 26 is provided, for example, at a deepest part thereof. The card detection sensor 26 detects whether the non-contact type IC card 25 is stored in the non-contact type IC card slot 22. The card detection sensor 26 is disposed at a position where the card detection sensor 26 is put in contact with an end portion of the non-contact type IC card 25 when the non-contact type IC card 25 is completely stored in the non-contact type IC card slot 22.

It should be noted, however, that since the non-contact type IC card 25 executes wireless communication with the IC card reader/writer 21, the non-contact type IC card 25 can execute data transmission/reception with the IC cad reader/writer 21 even in the state in which the non-contact type IC card 25 is not completely stored in the non-contact type IC card slot 22. Thus, it should suffice if the card detection sensor 26 can detect that the non-contact type IC card 25 is stored in such a position that the non-contact type IC card 25 can execute wireless communication with the IC card reader/writer 21.

FIG. 2 omits depiction of a mechanism for stably holding the non-contact type IC card 25 that is inserted in the non-contact type IC card slot 22, or a mechanism for taking out the non-contact type IC card 25 from the non-contact type IC card slot 22.

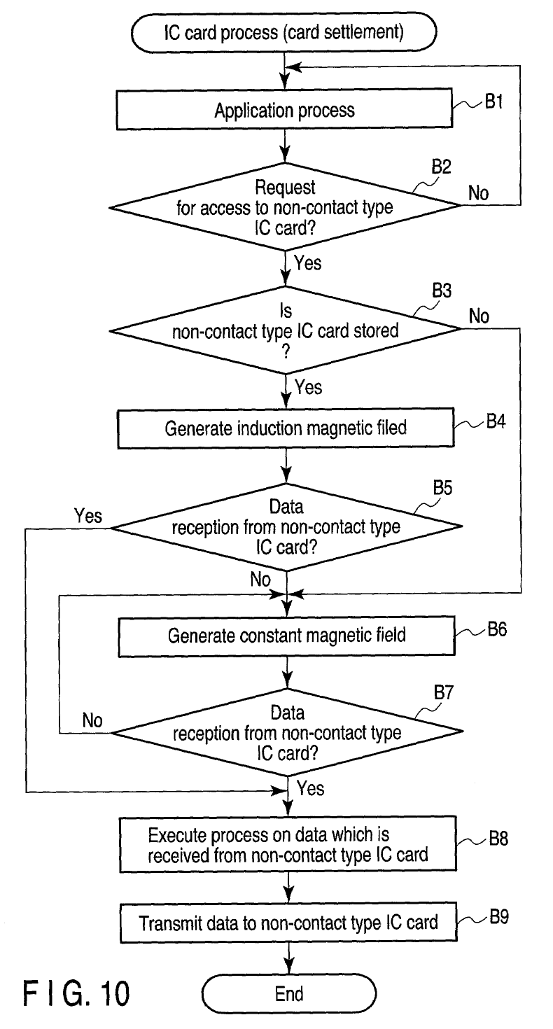

In FIG. 2, the card detection sensor 26 is provided to physically detect the non-contact type IC card 25. Alternatively, it is possible to detect, by other methods, that the non-contact type IC card 25 is stored in the non-contact type IC card slot 22 (for example, a built-in IC card detection process is illustrated in FIG. 10). In this case, the card detection sensor 26 may be omitted from the structure shown in FIG. 2.

In FIG. 2, the IC card reader/writer 21 is described as being provided on the top surface of the computer main body 11. However, it should suffice if an antenna for transmitting/receiving radio waves to/from the non-contact type IC card 25 is provided on the top surface of the computer main body 11. The parts of the IC card reader/writer 21, which is other than the antenna, may be configured to be disposed at other positions, and these parts may be connected to the antenna by a cable or the like.

In addition, in order to stabilize the state of wireless communication between the IC card reader/writer 21 and the non-contact type IC card 25 that is stored in the non-contact type IC card slot 22, it is possible to constitute the upper surface part of the non-contact type IC card slot 22 by a member which does not hinder wireless communication, or to form an opening in the upper surface part of the non-contact type IC card slot 22. Besides, it is possible to provide a member which covers the surrounding of the IC card reader/writer 21 and the non-contact type IC card slot 22 (non-contact type IC card 25), thereby to eliminate the influence of electromagnetic waves which are generated from other electronic components disposed in the computer main body 11.

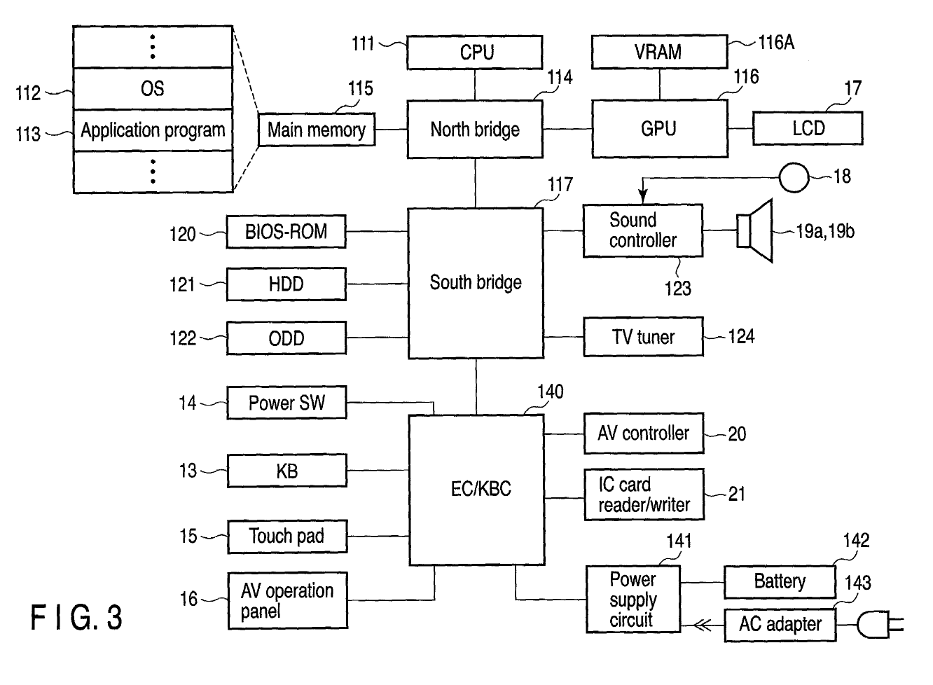

Next, referring to FIG. 3, the system configuration of the computer 10 is described.

The computer 10 comprises a CPU 111, a north bridge 114, a main memory 115, a graphics processing unit (GPU) 116, a south bridge 117, a BIOS-ROM 120, a hard disk drive (HDD) 121, an optical disc drive (ODD) 122, a sound controller 123, a TV tuner 124, an embedded controller/keyboard controller IC (EC/KBC) 140, and a power supply circuit 141.

The CPU 111 is a processor that is provided for controlling the operation of the computer 10. The CPU 111 executes an operating system (OS) 112 and various applications, such as an application program 113 that makes use of the non-contact type IC card 25, which are loaded from the HDD 121 into the main memory 115. The CPU 111 also executes a BIOS (Basic Input/Output System) that is stored in the BIOS-ROM 120.

The north bridge 114 is a bridge device that connects a local bus of the CPU 111 and the south bridge 117. The north bridge 114 includes a memory controller that access-controls the main memory 115. The north bridge 114 also has a function of executing communication with the graphics processing unit (GPU) 116 via, e.g. a PCI Express bus.

The graphics processing unit (GPU) 116 is a display controller which controls the LCD 17 that is used as a display monitor of the computer 10. The GPU 116 generates a video signal, which forms a screen image that is to be displayed on the LCD 17, on the basis of display data that is written in a video memory (VRAM) 116A by the OS or the application program.

The south bridge 117 includes an IDE (Integrated Drive Electronics) controller or a Serial ATA controller for controlling the hard disk drive (HDD) 121 and optical disc drive (ODD) 122.

The sound controller 123 is a sound source device and executes a process for outputting sound, which corresponds to various audio data, from the speakers 19a and 19b. The TV tuner 124 receives broadcast program data which is broadcast by a TV broadcast signal.

The embedded controller/keyboard controller IC (EC/KBC) 140 is a 1-chip microcomputer in which an embedded controller for power management and a keyboard controller for controlling the keyboard (KB) 13 and touch pad 15 are integrated. The EC/KBC 140 is always supplied with operation power from the power supply circuit 141 even in the state in which the computer 10 is powered off. The EC/KBC 140 functions as a controller for controlling the AV operation panel 16, AV controller 20 and IC card reader/writer 21. Communication between the EC/KBC 140 and AV controller 20 is executed via, e.g. a serial bus.

The EC/KBC 140 has a function of powering on/off the computer 10 in response to the user's operation of the power button switch 14. The power on/off control of the computer 10 is executed by cooperation of the EC/KBC 140 and power supply circuit 141. The power supply circuit 141 uses power from a battery 142 which is mounted in the computer main body 11 or power from an AC adapter 143 which is connected to the computer main body 11 as an external power supply, thereby generating operation powers to the respective components.

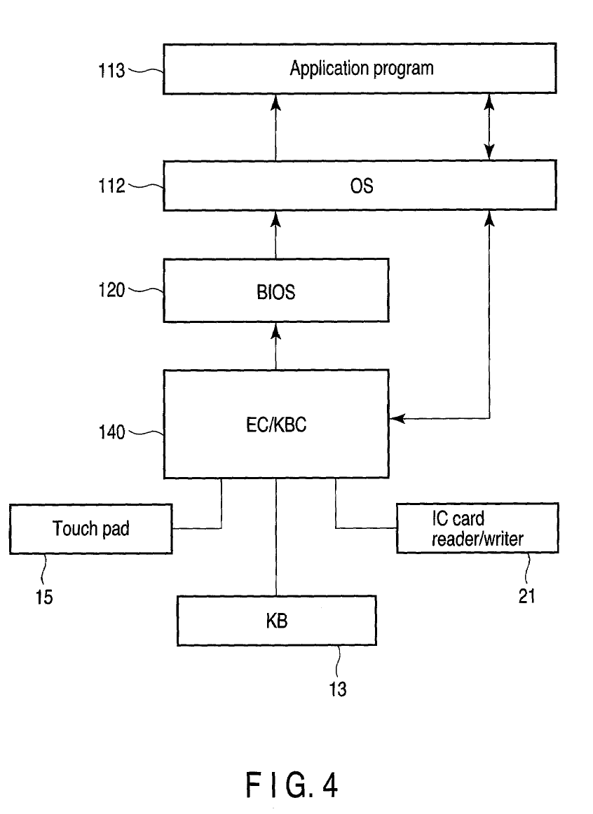

Next, referring to FIG. 4, the relationship between the hardware and software for controlling the IC card reader/writer 21 is described.

As has been described above, the keyboard 13, touch pad 15 and IC card reader/writer 21 are connected to the EC/KBC 140. A key code, which corresponds to a pressed key on the keyboard 13, is sent to the application program via the EC/KBC 140 and OS 112. In addition, data, which is input from the non-contact type IC card 25 by the IC card reader/writer 21, is sent to the application program 113, which utilizes the non-contact type IC card 25, for example, via the EC/KBC 140 and the OS 112.

In accordance with an instruction from the application program 113, the OS 112 controls the operation of the IC card reader/writer 21 via the EC/KBC 140. For example, in accordance with an instruction from the application program 113, the OS 112 can cause the IC card reader/writer 21 to generate an induction magnetic field. Specifically, in the case where a built-in non-contact type IC card 25 is stored in the non-contact type IC card slot 22 (the non-contact type IC card 25 in this stored state is referred to as “built-in non-contact type IC card 25”), no induction power can be generated by a constant magnetic field which is radiated from the IC card reader/writer 21. Thus, when data transmission/reception with the built-in non-contact type IC card 25 is executed, the OS 112 causes the IC card reader/writer 21 to generate such an induction magnetic field as to produce an induction power in the built-in non-contact type IC card 25 in the stop state.

In the case where the IC card reader/writer 21 is provided with a magnetic field radiation function which can arbitrarily radiate not only a constant magnetic file but also an induction magnetic field, the induction magnetic field can be radiated by controlling the IC card reader/writer 12 as described above. On the other hand, in the case where the IC card reader/writer 21 is provided with a magnetic field radiation function which can radiate only a constant magnetic field, it is possible to adopt such a structure that a magnetic field radiation function for radiating an induction magnetic field is provided in the vicinity of the non-contact type IC card slot 22 (and IC card reader/writer 21). This magnetic field radiation function includes, e.g. an antenna which is disposed near the non-contact type IC card slot 22, and is driven by a controller which can be controlled by, e.g. the OS 112. An induction magnetic field is generated by this magnetic field radiation function, and thereby electric power is induced in the non-contact type IC card 25 and the non-contact type IC card 25 is set in a state in which wireless communication with the IC card reader/writer 21 is enabled.

Next, the structure of the non-contact type IC card 25 is described.

FIG. 5 is a block diagram showing an example of the structure of the non-contact type IC card 25. The non-contact type IC card 25 is provided with, for instance, an antenna (loop antenna) 30 and a capacitor 31, as shown in FIG. 5, and the non-contact type IC card 25 transmits/receives a signal to/from the IC card reader/writer 21.

An interface module 37 detects a signal which is received via the antenna 30, and outputs the detected signal to a demodulation module 38. In addition, the interface module 37 transmits a signal, which is modulated by a modulation module 40, from the loop antenna 30. Further, the interface module 37 stabilizes the power, which is induced by the antenna 30, and supplies the power to the respective modules. Moreover, the interface module 37 generates, e.g. a clock signal which is necessary for operations, and supplies the clock signal to the respective modules.

A CPU 33 develops a control program, which is stored in a ROM 34, in a RAM 35, and controls the overall operation of the non-contact type IC card 25. For example, if radio waves, which are radiated from the IC card reader/writer 21, are received by the antenna 30 and power is supplied from the interface module 37, the CPU 33 transmits a card ID that is identification information and other data, which are set in an EEPROM 36 or ROM 34, to the IC card reader/writer 21 via a data transmission module 41. In addition, the CPU 33 processes data from the IC card reader/writer 21, which is input via a data reception module 39. The CPU 33 not only sends the card ID to the IC card reader/writer 21 (computer 10), but also executes various processes, such as an authentication process between itself and the IC card reader/writer 21, and an encryption/decryption process for data that is transmitted/received. For example, in the case where the non-contact type IC card 25 is used as electronic money, the CPU 33 executes a process of managing the electronic money (balance). The CPU 33 records data, which is indicative of the balance, in the EEPROM 36, and manages the data.

Next, the positional relationship between the IC card reader/writer 21, which is mounted on the computer 10, and the non-contact type IC card 25 is described.

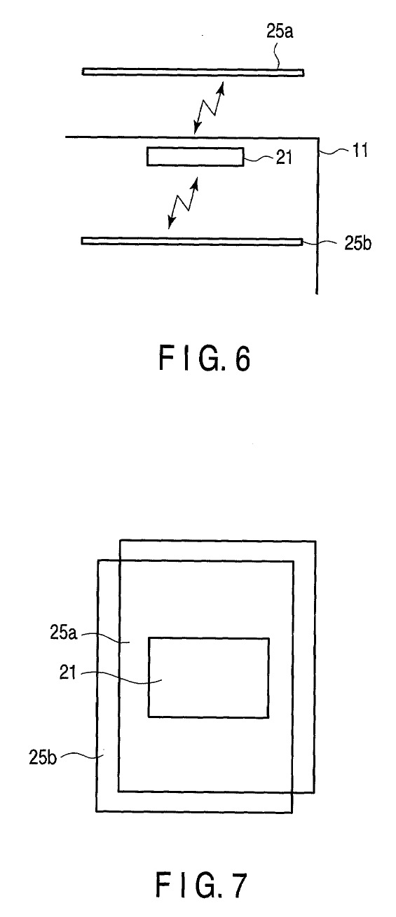

FIG. 6 shows the relative positional relationship between the IC card reader/writer 21 which is disposed in the casing of the computer main body 11, a non-contact type IC card 25a which is used outside the computer main body 11, and a non-contact type IC card 25b which is stored in the non-contact type IC card slot 22, as viewed from the lateral side. FIG. 7 shows the positional relationship between the IC card reader/writer 21 and the external and built-in non-contact type IC cards 25a and 25b, as viewed from above.

The IC card reader/writer 21 has such directivity as to be able to stably transmit/receive electromagnetic waves (signals) in the vertical direction in the state in which the computer 10 is horizontally disposed. The non-contact type IC card slot 22 is provided under the IC card reader/writer 21, and thereby signal transmission/reception can stably be executed with the non-contact type IC card 25 that is stored in the non-contact type IC card slot 22. In addition, the non-contact type IC card 25a is used in such a manner that the user holds the non-contact type IC card 25a over the position where the IC card reader/writer 21 is provided. Accordingly, the IC card reader/writer 21 can execute wireless communication with two non-contact type IC cards 25a and 25b in the upward and downward directions in which stable signal transmission/reception can be executed.

In the computer 10 according to the present embodiment, each of the non-contact type IC cards 25a and 25b may not only be used independently, but the two non-contact type IC cards 25a and 25b may also be used at the same time, as shown in FIG. 6 and FIG. 7. In the case where the two non-contact type IC cards 25a and 25b are used at the same time, there are a first mode and a second mode. In the first mode of use, in the state in which the non-contact type IC card 25b is stored in advance, the non-contact type IC card 25a is held over the IC card reader/writer 21. In the second mode of use, in the state in which the non-contact type IC card 25b is stored, the non-contact type IC card 25a is placed on the position on the top surface of the computer main body 11, where the IC card reader/writer 21 is provided.

Next, a description is given of the timing of wireless communication between the IC card reader/writer 21 and each non-contact type IC card 25a, 25b, in the case where the two non-contact type IC cards 25a and 25b are used at the same time.

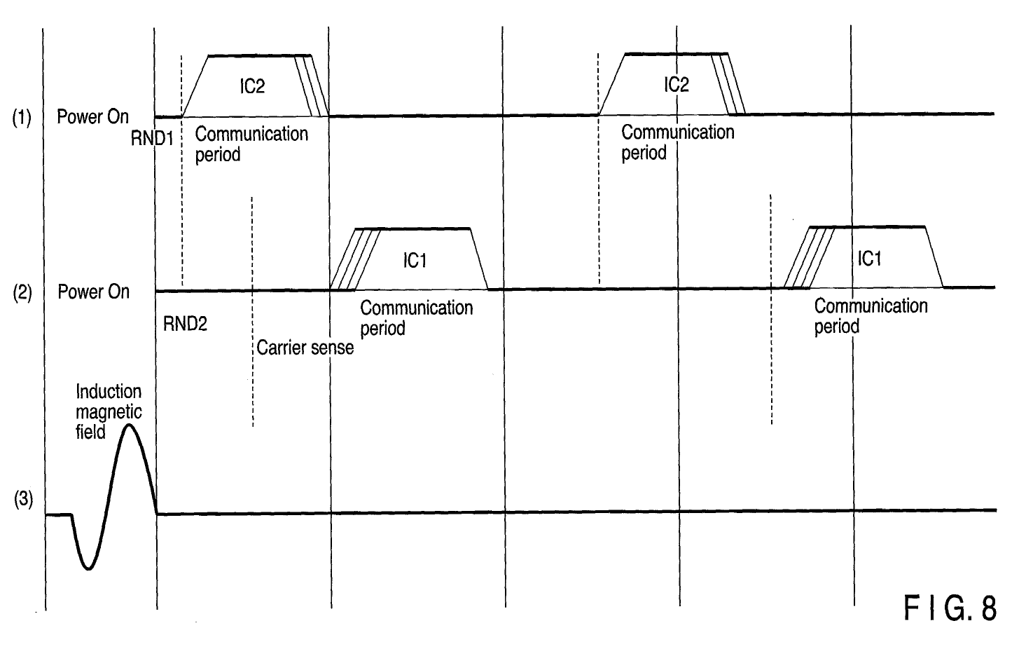

FIG. 8 shows time periods of communication between the two non-contact type IC cards 25a and 25b and the IC card reader/writer 21. In the description below, the above-described second mode of use is described by way of example.

While a constant magnetic field is generated in the state in which the non-contact type IC card 25 is stored in the non-contact type IC card slot 22 or placed on the computer main body 11, the IC card reader/writer 21 cannot execute data transmission/reception with the non-contact type IC card 25.

In this case, as shown in FIG. 8, in accordance with a request from the OS 112 (application program 113), the IC card reader/writer 21 generates an induction magnetic field which can cause the non-contact type IC card 25 to produce power. Thereby, the non-contact type IC cards 25a and 25b, which are positioned inside and outside the computer main body 11, produce power, respectively, and start operations for data transmission/reception with the IC card reader/writer 21 (parts (1) and (2) in FIG. 8).

When the non-contact type IC card 25 receives the signal from the IC card reader/writer 21 and starts the operation, the non-contact type IC card 25 generates, for instance, a random number, and start the operation for data transmission/reception at a timing corresponding to the value of the random number. Specifically, the non-contact type IC card 25 starts the operation for data transmission/reception with the IC card reader/writer 21 at a random timing which is determined individually. Thus, even if the IC card reader/writer 21 generates the induction magnetic field and thereby the two non-contact type IC cards 25a and 25b produce power at the same time and start operations, the timing of the start of the operation for data transmission/reception can be displaced between the two non-contact type IC cards 25a and 25b.

For example, part (1) of FIG. 8 shows a communication period of the first non-contact type IC card 25 which has first started the data transmission/reception operation. As shown in part (1) of FIG. 8, after the passing of a time (RND1) from the start of operation, the first non-contact type IC card 25 executes communication with the IC card reader/writer 21. On the other hand, part (2) of FIG. 8 shows a communication period of the second non-contact type IC card 25 which has subsequently started the data transmission/reception operation. As shown in part (2) of FIG. 8, after the passing of a time (RND2) which is longer than the time (RND1), the second non-contact type IC card 25 starts the operation for data transmission/reception. In other words, the second non-contact type IC card 25 executes carrier sense after the passing of the time (RND2). The second non-contact type IC card 25 starts communication with the IC card reader/writer 21 after the end of communication between the first non-contact type IC card 25 and the IC card reader/writer 21.

Next, a description is given of a method of detecting that the non-contact type IC card 25 is stored in the non-contact type IC card slot 22.

In the case where the non-contact type IC card 25 is stored in the non-contact type IC card slot 22, in order to execute communication with the non-contact type IC card 25, it is necessary, as described above, to generate the induction magnetic field from the IC card reader/writer 21. In order to determine whether it is necessary to generate the induction magnetic field by the IC card reader/writer 21, the computer 10 detects whether the non-contact type IC card 25 is stored in the non-contact type IC card slot 22.

(a) Method of Detection Using the Card Detection Sensor 26.

As shown in FIG. 2, the card detection sensor 26 is disposed in the non-contact type IC card slot 22, thereby to detect whether the non-contact type IC card 25 is stored in the non-contact type IC card slot 22. For example, the card detection sensor 26 reports the detection of the storage of the non-contact type IC card 25 to the CPU 111 via the EC/KBC 140. The OS 112 or application program 113 records data which indicates that the non-contact type IC card 25 is stored, and manages the state of the non-contact type IC card 25.

(b) Method of Detection by a Built-In IC Card Detection Process.

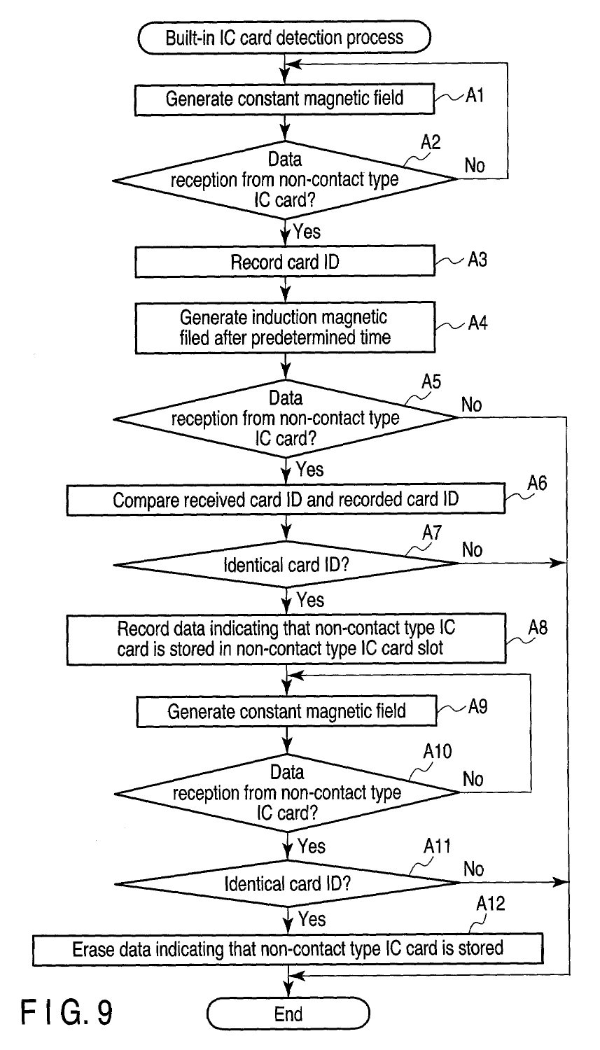

The CPU 111 of the computer 10 executes a built-in IC card detection process, which is illustrated in a flow chart of FIG. 9, thereby managing whether the non-contact type IC card 25 is stored in the non-contact type IC card slot 22. The built-in IC card detection process may be executed by the application program 113, or may be executed by the OS 112 in accordance with a request from the application program 113.

The built-in IC card detection process, which is executed by the CPU 111, will now be described with reference to the flow chart of FIG. 9.

The CPU 111 executes a block A1, and generates, as a steady state, a constant magnetic field by the IC card reader/writer 21. In this state, when the non-contact type IC card 25 is approached to the IC card reader/writer 21, data transmission/reception between the IC card reader/writer 21 and the non-contact type IC card 25 is enabled.

If data from the non-contact type IC card 25 is received in a block A2, the CPU 111 executes a block A3, receives a card ID from the non-contact type IC card 25 via the IC card reader/writer 21, and records the card ID. In this case, it cannot be determined whether the card ID has been received since the external non-contact type IC card 25a has been moved to the vicinity of the IC card reader/writer 21, or the card ID has been received since the non-contact type IC card 25b has been inserted in the non-contact type IC card slot 22.

After the passing of a predetermined time, the CPU 111 executes a block A4, and causes the IC card reader/writer 21 to generate an induction magnetic field. The predetermined time, in this case, is normally set at a time (e.g. about 2 seconds) which is long enough to complete an operation on the IC card reader/writer 21 in the case where the external non-contact type IC card 25a is used.

If no data is received from the non-contact type IC card 25 when the induction magnetic field is generated after the predetermined time (No in block A5), the CPU 111 determines that the non-contact type IC card 25 is not stored in the non-contact type IC card slot 22.

On the other hand, if data is received from the non-contact type IC card 25 when the induction magnetic field is generated after the predetermined time (Yes in block A5), the CPU 111 compares, in block A6, the received card ID and the previously received card ID. If the compared card IDs are not identical (No in block A7), the computer 10 determines that the non-contact type IC card 25 is not stored in the non-contact type IC card slot 22.

If the compared card IDs are identical (Yes in block A7), the computer 10 determines that the non-contact type IC card 25 is stored in the non-contact type IC card slot 22, and records, in block A8, data which indicates the state in which the non-contact type IC card 25 is stored.

Specifically, when the non-contact type IC card 25 is stored in the non-contact type IC card slot 22, the card ID is received by the IC card reader/writer 21. Then, if the same non-contact type IC card 25 remains in the stored state in the non-contact type IC card slot 22, the card ID is received from the same non-contact type IC card 25 by the generation of the induction magnetic field. Therefore, if the same card ID is received when the constant magnetic field is generated and the induction magnetic field is generated, it can be determined that the non-contact type IC card 25 is stored in the non-contact type IC card slot 22.

Thereafter, the computer 10 causes the IC card reader/writer 21 to generate a constant magnetic field (block A9). If the card ID is received from the non-contact type IC card 25 (Yes in block A1) and this card ID is identical to the card ID of the built-in non-contact type IC card 25 (Yes in block All), the CPU 111 determines that the non-contact type IC card 25 has been taken out of the non-contact type IC card slot 22. In block A12, the CPU 111 erases the data that indicates the state in which the non-contact type IC card 25 is stored.

As has been described above, the magnetic field that is generated from the IC card reader/writer 21 is switched between the constant magnetic field and the induction magnetic field. On the basis of the card IDs which are read from the non-contact type IC card 25 when the constant magnetic field is generated and when the induction magnetic field is generated, it is possible to detect whether the non-contact type IC card 25 is stored in the non-contact type IC card slot 22.

In the above description, it is detected whether the non-contact type IC card 25 is stored in advance in the non-contact type IC card slot 22. However, the above-described process may be omitted in the case where the non-contact type IC card 25 does not need to be stored in advance in the non-contact type IC card slot 22 in the application process that is executed by the application program 113, that is, in the case where data may be read from whichever of the external and built-in non-contact type IC cards 25a and 25b.

In this case, an induction magnetic field is generated at a time point when data transmission/reception with the non-contact type IC card 25 has become necessary. At this time, if data from the non-contact type IC card 25 is not received, it is determined that the non-contact type IC card 25 is not stored in the non-contact type IC card slot 22, and a constant magnetic field is generated from the IC card reader/writer 21. Then, a transition occurs to a standby state for waiting for data reception from the non-contact type IC card 25, which occurs when the user holds the non-contact type IC card 25 over the IC card reader/writer 21.

Next, a description is given of a specific process using the non-contact type IC card 25 of the computer 10 according to the present embodiment.

FIG. 10 is a flow chart illustrating a IC card process for executing card settlement by the non-contact type IC card 25 having a charge settlement function (e.g. electronic money).

To begin with, the CPU 111 executes an application process relating to card settlement, according to the application program 113 (block B1). For example, the CPU 111 executes the application program 113, and executes, e.g. confirmation of a charge that is to be settled by the non-contact type IC card 25, in accordance with an instruction from the user. In the case where an instruction for settlement by the non-contact type IC card 25 is input by the user, that is, in the case where a request for access to the non-contact type IC card 25 occurs (Yes in block B2), the CPU 111 causes the IC reader/writer 21 to execute communication with the non-contact type IC card 25.

In the case where the non-contact type IC card 25 is stored in the non-contact type IC card slot 22 in the computer main body 11 (Yes in block B3), the CPU 111 causes, in block B4, the IC card reader/writer 21 to generate an induction magnetic field according to the application program 113 (or the OS 112), thereby enabling data transmission/reception between the IC card reader/writer 21 and the non-contact type IC card 25. It is assumed that whether the non-contact type IC card 25 is stored or not has been detected in advance by the above-described card detection sensor 26 or the built-in card detection process.

In the case where data (e.g. card ID) is received from the non-contact type IC card 25 (Yes in block B5), the CPU 111 causes, according to the application program 113, the IC card reader/writer 21 to execute data transmission/reception with the non-contact type IC card 25 in connection with the card settlement, and executes a process for card settlement on the data received from the non-contact type IC card 25 (block B8). For example, in the case where the non-contact type IC card 25 is equipped with a pre-paid type charge payment function, the CPU 111 calculates post-settlement data (i.e. the balance) in block B9, and sends the data to the non-contact type IC card 25 via the IC card reader/writer 21.

If the non-contact type IC card 25 is not stored in the computer main body 11 (No in block B3) or if no data is received from the non-contact type IC card 25 even when the induction magnetic field is generated (No in block B5), the CPU 111 causes, according to the application program 113 (or the OS 112), the IC card reader/writer 21 to generate a constant magnetic field, thus waiting for data reception from the external non-contact type IC card 25a (block B6). Specifically, the CPU 111 waits for the user's operation of approaching the non-contact type IC card 25a to the IC card reader/writer 21.

In the case where data is received from the non-contact type IC card 25 (Yes in block B7), the CPU 111 executes, in block B8 and block B9, a process on the data received from the non-contact type IC card 25, in the same manner as described above, and sends the processed data to the non-contact type IC card 25 via the IC card reader/writer 21.

As has been described above, in the computer 10 according to the present embodiment, if the non-contact type IC card 25 is stored in the non-contact type IC card slot 22, the card process can be executed without the user's operation of holding (approaching) the non-contact type IC card 25 over the IC card reader/writer 21 at the time of card settlement. Thus, even in the case where card settlement needs to be performed twice or more, it should suffice if the non-contact type IC card 25 remains in the non-contact type IC card slot 22, and the handling of the non-contact type IC card 25 by the user becomes easier.

Next, a description is given of specific examples of the case of using two non-contact type IC cards 25 at the same time in the computer 10 according to the present embodiment.

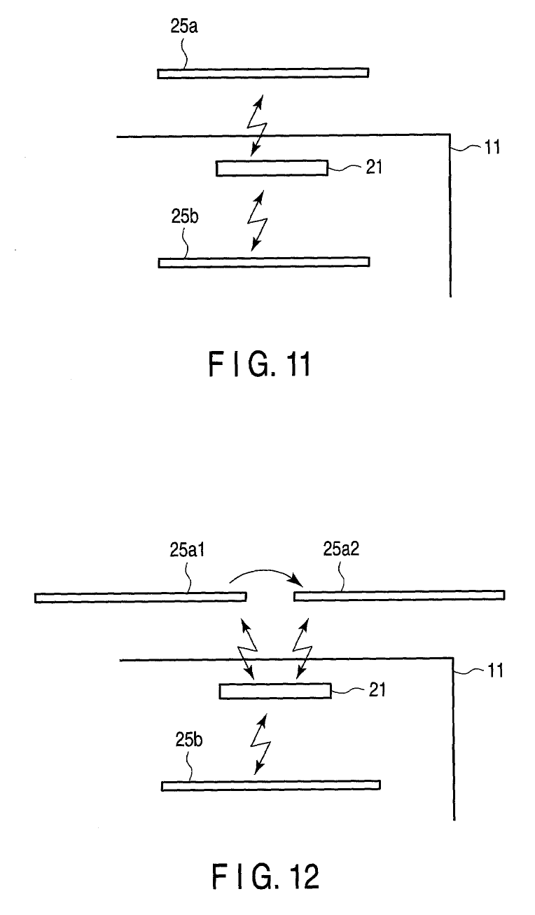

In the computer 10 according to the present embodiment, in the state in which the non-contact type IC card 25b is stored in the non-contact type IC card slot 22, data transmission/reception with the external non-contact type IC card 25a can be executed by the IC card reader/writer 21. By making use of this feature, it is possible to execute a first IC card process shown in FIG. 11 and a second IC card process shown in FIG. 12.

FIG. 11 illustrates the first IC card process in which a data transaction is executed between two non-contact type IC cards 25a and 25b via the IC card reader/writer 21. For example, assume that the non-contact type IC cards 25a and 25b have electronic money functions, and money values can be charged in the IC cards 25a and 25b. In this example, a process of transferring the money value, which is charged in the built-in non-contact type IC card 25b, into the external non-contact type IC card 25a is executed. It is assumed that the external non-contact type IC card 25a is placed on a position on the computer main body 11, where the IC card reader/writer 21 is provided.

FIG. 12 illustrates the second IC card process for a data transaction between two external non-contact type IC cards 25a1 and 25a2 via the IC card reader/writer 21 and the built-in non-contact type IC card 25b. In this example, points recorded in the non-contact type IC card 25a1 are transferred to the other non-contact type IC card 25a2 via the built-in non-contact type IC card 25b.

FIG. 11 and FIG. 12 are views showing the relationship between the IC card reader/writer 21 and the non-contact type IC card 25a, 25b, and are not views showing the relative physical positions thereof.

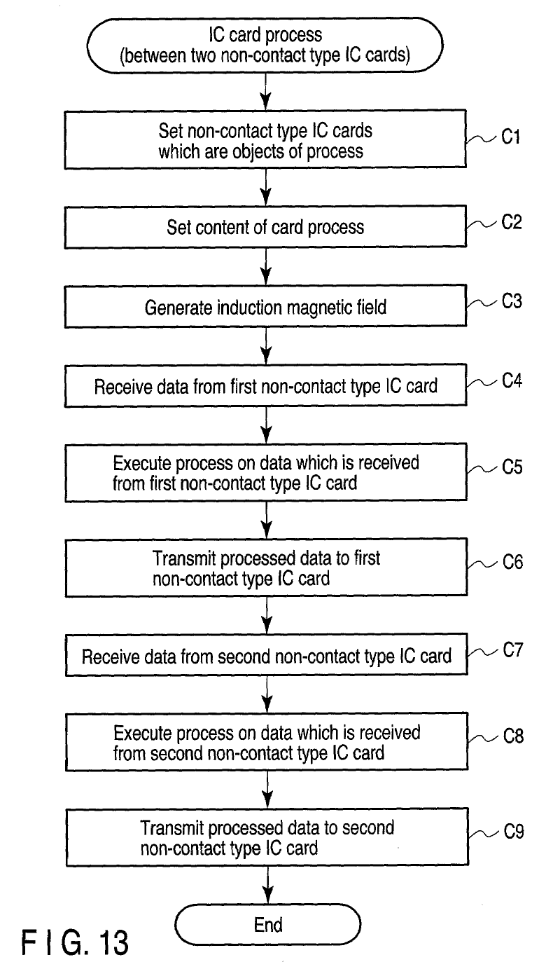

To begin with, the IC card process shown in FIG. 11 is described with reference to a flow chart of FIG. 13.

The CPU 111 executes the application program 113, and executes settings of non-contact type IC cards 25 that are objects of the process, for example, by the user's operation on the keyboard 13 or touch pad 15 (block C1). For example, the CPU 111 registers in advance the non-contact type IC cards 25 that are objects of the first IC card process, by the process of the application program 113. Specifically, the CPU 111 reads in the card IDs from the non-contact type IC cards 25 and records the card IDs (block C2). The CPU 111 prompts the user to select the charge source and the transfer destination of money values from among the plural pre-registered non-contact type IC cards 25 (card IDs).

In addition, the CPU 111 sets the content of the card process. In this example, the money value (amount), which is transferred from the non-contact type IC card 25 that is the charge source of the money value to the non-contact type IC card 25 that is the transfer destination, is set in accordance with the user's instruction.

The data relating to the users of the respective non-contact type IC cards 25 is recorded in advance in association with the card ID. Thereby, such an instruction can be issued as to transfer the money value of 5000 yen from the non-contact type IC card 25, which is possessed by the father, to the non-contact type IC card 25, which is possessed by a child.

If the content of the process is thus set and the execution of the process is instructed, the CPU 111 informs the IC card reader/writer 21 of the card IDs (the charge source and transfer destination) of the non-contact type IC cards 25 that are the objects of the process, and the data indicative of the money value (amount) that is to be transferred. In addition, the OS 112 causes the IC card reader/writer 21 to generate an induction magnetic field (block C3).

If the IC card reader/writer 21 receives the data including the card ID and the charge amount from the first non-contact type IC card 25 (block C4), the process on the data received from the first non-contact type IC card 25 is executed (block C5).

For example, if the card ID received from the first non-contact type IC card 25 is the card ID that is set as the charge source, an amount corresponding to the money value transfer that is instructed from the application program 113 is subtracted from the current charge amount. The IC card reader/writer 21 transmits the data, which is obtained after subtracting the amount corresponding to the money value transfer, to the first non-contact type IC card 25 (block C6).

On the other hand, if the IC card reader/writer 21 receives the data including the card ID and the charge amount from the second non-contact type IC card 25 (block C7), the process on the data received from the second non-contact type IC card 25 is executed (block C8).

For example, if the card ID received from the second non-contact type IC card 25 is the card ID that is set as the transfer destination, the amount that has been subtracted from the charge amount of the first non-contact type IC card 25 (i.e. the amount instructed from the application program 113) is added to the current charge amount that is read out. The IC card reader/writer 21 transmits the data, which has been obtained after the process, to the second non-contact type IC card 25 (block C9).

The above description is directed to the case in which data is first received from the non-contact type IC card 25 (built-in non-contact type IC card 25b) that is the charge source. However, there may be a case in which data is first received from the non-contact type IC card 25 (external non-contact type IC card 25a) that is the transfer destination. In this case, too, the same process as described above may be executed on the non-contact type IC cards that are the charge source and transfer destination.

As has been described above, by simplifying the handling of the non-contact type IC cards 25a and 25b, the data transaction can be executed between the non-contact type IC card 25b, which is stored in the non-contact type IC card slot 22, and the external non-contact type IC card 25a via the IC card reader/writer 21.

In addition, since the data transaction between the non-contact type IC card 25a and non-contact type IC card 25b is executed via the IC card reader/writer 21, the authenticity of data can be ensured. In other words, when the data transaction is executed between the non-contact type IC card 25a, 25b and the IC card reader/writer 21, a process, such as an authentication process or an encryption/decryption process, is performed as an intervening process, and therefore tampering of data, for example, can be prevented.

In the process shown in FIG. 13, the CPU 111 causes the IC card reader/writer 21 to generate the induction magnetic field once, thereby executing data transmission/reception of the two non-contact type IC cards 25a and 25b and completing the process. Alternatively, the data reception from the non-contact type IC card 25a, 25b may be executed separately from the data transmission to the non-contact type IC card 25a, 25b, and induction magnetic fields may be generated from the IC card reader/writer 21 at the time of data reception and at the time of data transmission, respectively.

For example, data is received from the two non-contact type IC cards 25a and 25b by the induction magnetic field that is generated at the first time, and the process on the data received therefrom is executed. At this time, which of the non-contact type IC cards 25 is to be chosen, the data from which is to be processed, and what kind of process is to be executed on this data, are determined on the basis of the card ID and the process content which are instructed in advance from the application program 113. Subsequently, the IC card reader/writer 21 generates the induction magnetic field at the second time. At this time, the IC card reader/writer 21 transmits the processed data to each card, on the basis of the card ID that is received from the non-contact type IC card 25a, 25b.

In the case where the induction magnetic field is generated at the second time, it is possible that the communication between the IC card reader/writer 21 and the non-contact type IC card 25a, 25b is executed in an order different from the order at the time when the induction magnetic filed is generated at the first time, as explained with reference to FIG. 8. However, the matching can be established on the basis of the card IDs.

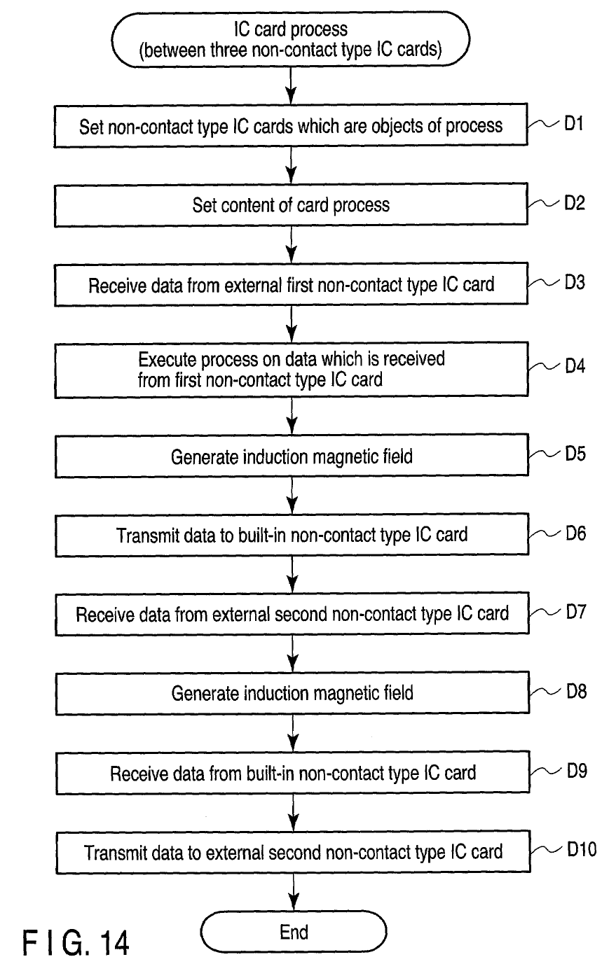

Next, the second IC card process shown in FIG. 12 is described with reference to a flow chart of FIG. 14.

The CPU 111 executes the application program 113, and executes settings of non-contact type IC cards 25 that are objects of the process, for example, by the user's operation on the keyboard 13 or touch pad 15 (block D1). The settings of the non-contact type IC cards 25 that are objects of the process are executed in the same manner as in the above-described first IC card process (block D2). Then, the CPU 111 sets the content of the card process in accordance with an instruction from the user. In this example, all points recorded in the non-contact type IC card 25a1, the communication with which occurs earlier, are transferred to the non-contact type IC card 25a2, the communication with which occurs later.

If the process content is thus set and the execution of the process is instructed, the CPU 111 informs the IC card reader/writer 21 of the card IDs of the non-contact type IC cards 25 that are the objects of the process, and the data indicative of the process content (transfer of all points). In addition, the OS 112 causes the IC card reader/writer 21 to generate a constant magnetic field, thus enabling wireless communication with the external non-contact type IC card 25.

If data is received from the external first non-contact type IC card 25 (non-contact type IC card 25a1) (block D3), the IC card reader/writer 21 executes a process on the data that is received from the non-contact type IC card 25a1 (block D4). Specifically, the non-contact type IC card 25a1, which is the object of the process, is confirmed on the basis of the card ID, and the data indicative of the recorded points is acquired. Then, the points that are recorded in the non-contact type IC card 25a1 are decreased to zero.

The IC card reader/writer 21 generates an induction magnetic field (block D5) and transmits the points, which are received from the non-contact type IC card 25a1, to the non-contact type IC card 25b which is stored in the non-contact type IC card slot 22 (block D6). The non-contact type IC card 25b records the points which are received from the IC card reader/writer 21.

Then, the IC card reader/writer 21 transitions to a data reception wait state by radiating a constant magnetic field, thereby to enable data communication with the external second non-contact type IC card 25 (non-contact type IC card 25a2) that is the destination of the transfer of points.

If the IC card reader/writer 21 receives the card ID from the external non-contact type IC card 25 and confirms that this IC card 25 is the non-contact type IC card 25a2 that is the object of the process (block D7), the IC card reader/writer 21 generates an induction magnetic field in order to read out the points recorded in the built-in non-contact type IC card 25b (block D8).

The IC card reader/writer 21 receives the data of the points from the non-contact type IC card 25b (block D9) and sends the data to the non-contact type IC card 25a2 (block D10). The non-contact type IC card 25a2 records the data of the points, which is received from the IC card reader/writer 21.

As has been described above, the data transaction between the two non-contact type IC cards 25a1 and 25a2 can be executed via the non-contact type IC card 25b which is stored in the non-contact type IC card slot 22. The process on the non-contact type IC card 25b can be executed in the state in which the non-contact type IC card 25b is stored in the non-contact type IC card slot 22. Thus, even if three non-contact type IC cards 25 are used, the handling of the IC cards is not time-consuming. In addition, since the data transaction is executed via the non-contact type IC card 25b, the authenticity of data can be ensured.

In the above description, one non-contact type IC card slot 22 is provided. Alternatively, a plurality of slots (storing modules) may be provided, and a plurality of non-contact type IC cards 25 may be stored at the same time in the casing of the computer main body 11. For example, the IC card reader/writer 21 (antenna unit) may be disposed in the casing of the computer main body 11, and the non-contact type IC card slot 22 may be provided on each of the upper side and lower side of the IC card reader/writer 21. In this case, a plurality of non-contact type IC cards 25 can be stored at the same time in the casing of the computer main body 11. In this state, communication can be executed by the IC card reader/writer 21 between the plural non-contact type IC card 25.

In the above description, the non-contact type IC card slot 22 is configured such that the non-contact type IC card 25 is detachably inserted in the non-contact type IC card slot 22. Alternatively, the non-contact type IC card 25 may be fixedly and irremovably stored.

In the case where the non-contact type IC card slot 22 is configured such that the non-contact type IC card 25 is detachably inserted in the non-contact type IC card slot 22, a lock mechanism may be provided to prevent easily detachment of the non-contact type IC card 25. Specifically, in the case where the non-contact type IC card 25 is usable as electronic money, if a third person takes possession of the non-contact type IC card 25 by a theft or the like, the non-contact type IC card 25 may possibly be unlawfully used. Thus, even if the user moves away from the computer 10, the non-contact type IC card 25 is prevented from being easily taken out from the non-contact type IC card slot 22 by a third person. For example, in the case where the computer 10 is equipped with an authentication function for authenticating the user, unlocking is enabled only when it is confirmed by the authentication function that the user is authentic, so that the non-contact type IC card 25 may be taken out from the non-contact type IC card slot 22.

In the above description, the non-contact type IC card 25, which is stored in the non-contact type IC card slot 22, is connected by wireless communication via the IC card reader/writer 21. Alternatively, the non-contact type IC card 25 may be physically connected. In this case, the non-contact type IC card 25 is provided with an external terminal which enables electrical connection. This external terminal may be provided on one of the upper and lower surfaces of the non-contact type IC card 25 or on one of the sides of the non-contact type IC card 25. In addition, the non-contact type IC card slot 22 is provided with a connection terminal at such a position that the connection terminal comes in contact with the external terminal of the non-contact type IC card 25 when the non-contact type IC card 25 is stored in the non-contact type IC card slot 22. Thereby, when the non-contact type IC card 25 is stored in the non-contact type IC card slot 22, the external terminal of the non-contact type IC card 25 is electrically connected to the connection terminal of the non-contact type IC card slot 22.

By the electrical connection to the non-contact type IC card 25, the computer 10 can detect that the non-contact type IC card 25 has been stored in the non-contact type IC card slot 22. In addition, the computer 10 can control the operation of the non-contact type IC card 25. For example, with the application of a predetermined voltage to the non-contact type IC card 25, the computer 10 can switch the state of the non-contact type IC card 25 between an operable state and an inoperable state. Thereby, in accordance with the process content that is set by the application, the computer 10 renders the non-contact type IC card 25, which is stored in the non-contact type IC card slot 22, for example, in the inoperable state, so that only wireless communication with the external non-contact type IC card 25 may be enabled.

In the above description, the computer main body 11 is provided with the IC card reader/writer 21 that can execute data read/write from/to the non-contact type IC card 25. However, in the case where the IC card process that is executed by the computer 10 (application program 113) does not require data write to the non-contact type IC card 25, an IC card reader which reads data from the non-contact type IC card 25 may be mounted.

In the above description, the notebook portable personal computer 10 is taken as an example. The present invention, however, is applicable to various information processing apparatuses which are equipped which IC card reader/writers 21 (or IC card readers).

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a communication device in a casing configured to wirelessly communicate with a first non-contact type IC card; and
a card slot configured to hold the first non-contact type IC card, the card slot being provided at such a position that communication is enabled between the first non-contact type IC card and the communication device.

2. The information processing apparatus of claim 1, further comprising a magnetic field radiation module configured to radiate an induction magnetic field provided near the card slot.

3. The information processing apparatus of claim 2, wherein the magnetic field radiation module is provided in the communication device.

4. The information processing apparatus of claim 2, wherein
the communication device is provided on an upper surface portion of the casing; and
the card slot is provided under the communication device in such a manner that a second non-contact type IC card placed on the communication device and the first non-contact type IC card are positioned symmetric with the communication device being interposed.

5. The information processing apparatus of claim 2, wherein the communication device is configured to wirelessly communicate with the first non-contact type IC card held in the card slot and the second non-contact type IC card positioned outside the casing.

6. The information processing apparatus of claim 2, wherein the card slot is configured to hold the first non-contact type IC card in such a manner that the first non-contact type IC card is detachably held.

7. The information processing apparatus of claim 2, further comprising a detection module configured to detect that the first non-contact type IC card is held in the card slot.

8. The information processing apparatus of claim 7, wherein the detection module comprises a sensor configured to detect that the first non-contact type IC card is held by sensing that the sensor is in contact with the first non-contact type IC card when the first non-contact type IC card is held in the card slot.

9. The information processing apparatus of claim 7, wherein the detection module comprises:
an identification information recording module configured to record first identification information of the card received from the first non-contact type IC card while a constant magnetic field is being radiated from the communication device;
a magnetic field radiation controller configured to control the magnetic field radiation module radiating the induction magnetic field after a predetermined time from a time when the identification information is recorded by the identification information recording module; and
a determination module configured to determine whether the first non-contact type IC card is held in the card slot when second identification information received from the first non-contact type IC card corresponds with the first identification information recorded by the identification information recording module after the induction magnetic field is radiated by the magnetic field radiation controller.
